(19) United States
(12) Patent Application Publication
(10) Pub. No.: US 2011/0251849 A1
(43) Pub. Date: Oct. 13, 2011

(54) Healthcare System and Method

(75) Inventors: Gerrit J. van Zyl, Craighall Park (ZA); Luis H. da Silva, Bedfordview (ZA)

(73) Assignee: Tradebridge (Proprietary) Limited, Bryanston (ZA)

(21) Appl. No.: 13/082,982

(22) Filed: Apr. 8, 2011

Related U.S. Application Data
(60) Provisional application No. 61/321,947, filed on Apr. 8, 2010.

(51) Int. Cl. G06Q 50/00

(52) U.S. Cl. 705/2

(57) ABSTRACT

A healthcare system includes a database having stored thereon patient information data, patient medical data, treatment plans data and healthcare provider data. A treatment module accesses the data stored in the database and uses the data to determine a plurality of patient treatment steps required to implement a treatment plan thereby to treat the patient. A communications module communicates with a healthcare provider system to instruct the healthcare provider to perform a next activity of the patient treatment activity required in the treatment of the patient and a monitoring module monitors that the next activity has been performed. In addition, an awards module determines an award for the healthcare provider or their agent if the healthcare provider or their agent performs the next activity in the treatment of the patient.

### RELATED APPLICATIONS

This application claims priority to U.S. provisional patent application No. 61/321,947, entitled “HEALTHCARE SYSTEM AND METHOD,” filed on Apr. 8, 2010, which is hereby incorporated by reference in its entirety.

### BACKGROUND OF THE INVENTION

Embodiments described herein relate to a healthcare system and method.

It is widely documented that a large portion of clinical healthcare expenditure is allocated to patients with a chronic condition such as diabetes, hypertension, chronic heart disease, asthma and HIV, for example.

It is also well known that patients with a chronic condition that look after themselves and follow their treatment plans require less healthcare expenditure than those patients that do not follow their treatment plans. In fact, it has been shown that patients not complying with treatment plans have complication costs of up to five times the complication costs of patients complying with their treatment plans.

Embodiments described herein seek to address this.

### SUMMARY

According to a first example embodiment there is provided a healthcare system including:

a treatment module to access at least some of patient information data, patient medical data, treatment plans data and healthcare provider data stored in at least one database and to use the data to determine a plurality of patient treatment activities required to implement a treatment plan thereby to treat the patient;

a communications module to communicate with a healthcare provider system to instruct the healthcare provider or their agent to perform a next activity of the patient treatment activities required in the treatment of the patient; and

a monitoring module to monitor that the next activity has been performed.

According to another example embodiment there is provided a healthcare method including:

accessing patient information data, patient medical data, insurer treatment plans data and healthcare provider data stored in a database and using the data to determine a plurality of patient treatment activities required to implement a treatment plan thereby to treat the patient;

communicating with a healthcare provider system to instruct the healthcare provider or their agent to perform the next activity in the treatment of the patient; and

monitoring that the next activity has been performed.

### BRIEF DESCRIPTION OF THE DRAWINGS

FIG. 1 is a schematic view of one environment in which one embodiment of a healthcare system operates;

FIG. 2 is a block diagram illustrating an example of a healthcare system; and

FIG. 3 is a flow chart illustrating the methodology of an example embodiment.

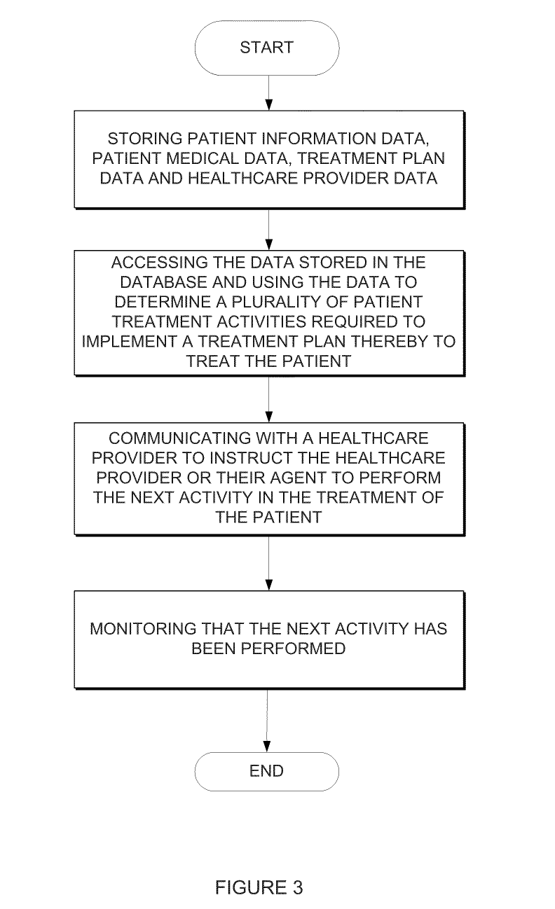

### DETAILED DESCRIPTION OF THE DRAWINGS

As discussed above, data indicates that more than 50% of clinical healthcare spend is on patients with a chronic disease. These patients form a minority of the population and so it transpires that the majority of clinical healthcare spend is on a minority of the population.

Treatment protocols for every major chronic disease have been developed over the last 20 years using evidence-based medicine principles. Treatment protocols are sometimes referred to as medical guidelines (also called a clinical guideline, clinical treatment protocols or clinical practice guideline) and are documents with the aim of guiding decisions and criteria regarding diagnosis, management, and treatment in specific areas of healthcare.

Treatment protocols are typically made up from rules and a treatment plan.

Treatment plans are also known as clinical pathways, care pathways, critical pathways, integrated care pathways, or care maps, are one of the main tools used to manage the quality in healthcare concerning the standardization of care processes. It has been proven that their implementation reduces the variability in clinical practice and improves outcomes. Treatment plans promote organized and efficient patient care based on the evidence based practice. Treatment plans optimize outcomes in the acute care and homecare settings.

These treatment plans have been shown to reduce the overall long-term cost of treating patients considerably.

However, one of the biggest problems is how to practically implement treatment plans, which include a plurality of treatment steps, into a plurality of treatment activities (atomic actions required to fulfill a single treatment step) and then how to ensure that all the stakeholders in the process are engaged to make the treatment activities happen.

This is well understood in most sophisticated health markets. However, the devil is in the details in how to achieve compliance between the healthcare provider and the treatment plan, between the patient and the treatment plan and between the patient and the healthcare provider.

This problem is further complicated because very often the right information is not present at the right place at the right time. For example, when a patient arrives at a new doctor the doctor must make important treatment decisions based only on the often incomplete information that the patient supplies.

During a consultation the doctor will ask whether the patient is taking the chronic medication as prescribed. Studies have shown that many patients who have not been taking medication have a propensity to lie. The doctor does not have the information regarding the frequency of dispensing and the number of days supply provided to the patient which gives an indication of usage.

When doctors make referrals to other specialists, it is also rare that useful contextual information is passed along to the specialist (e.g. test results, history, etc).

Finally, although reference has been made above to patients with chronic conditions, on review of the method and system described below it will be appreciated that the method and system could be applied to any patient medical condition that needs to be treated, including but not limited to any medical or trauma induced illness or injury or a condition such as pregnancy.

Embodiments described herein seek to provide a system to co-ordinate healthcare practitioners, insurers, patients and any other relevant stakeholder to adhere to practical treatment plans based on protocols and to ensure that information is stored centrally and made available to all parties.

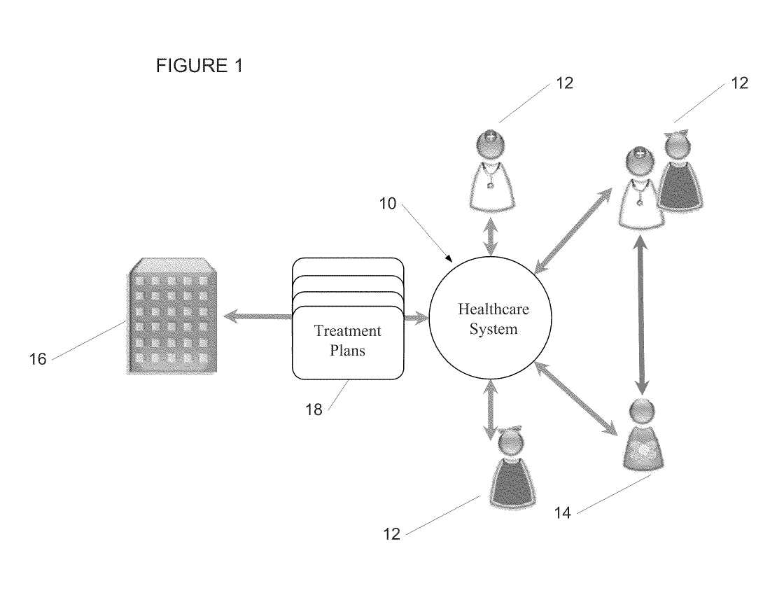

Referring to FIG. 1, there is provided an example embodiment of a healthcare system 10.

In certain embodiments, the system 10 is placed centrally in communication with healthcare providers and ancillary healthcare services 12, patients 14 and healthcare insurers 16. This is typically done via appropriate communications networks such as the Internet, private data networks, mobile or fixed line telephone networks or any other type of network.

In one example embodiment the treatment plans 18 are supplied to the system 10. These treatment plans can be formulated by a treatment plan manager that may be one or more stakeholders such as a health insurer, a medical practitioner and a managed care provider to name but a few examples. This will be described in more detail below.

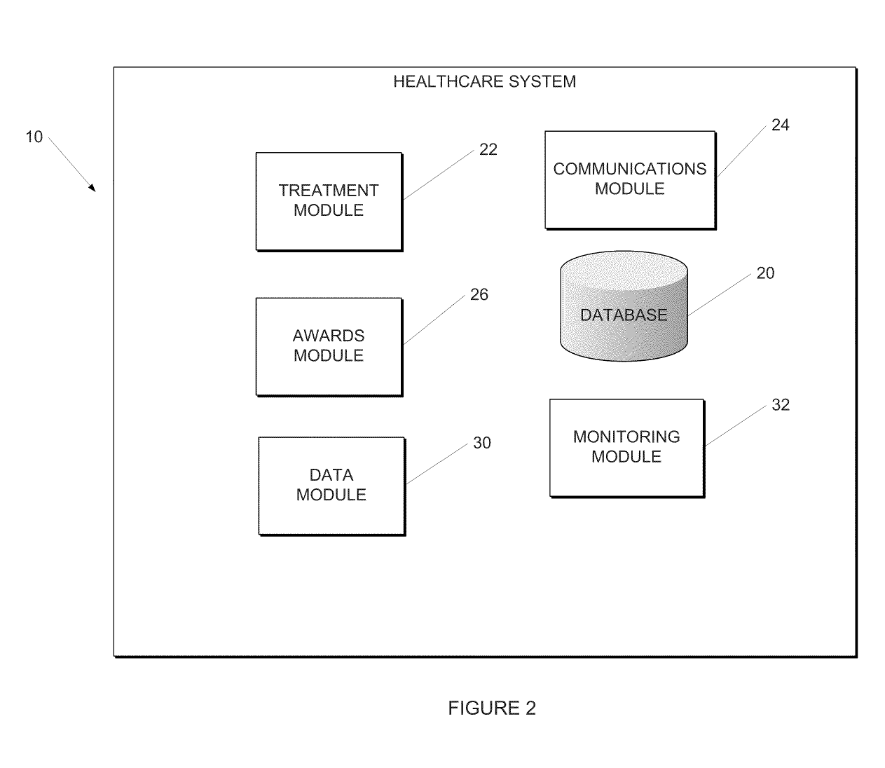

The system 10, after receiving the treatment plan 18 including the treatment steps, stores these in a memory in the form of a database 20 shown in FIG. 2. It will be appreciated that the memory may take any suitable form and may be spread over more than one location and/or memory module.

The system 10 may include various modules which will be described in more detail.

The modules may be implemented by a machine-readable medium embodying instructions which, when executed by a machine, cause the machine to perform any of the methods described above.

It will be appreciated that embodiments described herein are not limited to such architecture, and could equally well find application in a distributed, or peer-to-peer, architecture system. Thus the modules illustrated could be located on one or more servers operated by one or more institutions.

In any event, the database 20 contains various types of data such as patient information data, patient medical data, treatment plan data and healthcare provider data.

Patient information data typically includes the patient's personal details such as their name, gender, age, personal identity number and any other relevant personal information.

The patient medical data will include all relevant information about the patient's medical condition. For example this may include at least some of medical history, allergies, medication that the patient has taken in the past or is currently taking and any other treatments that the patient has historically had or is currently undergoing.

The treatment plan data includes all relevant treatment plan information from one or more stake holders as mentioned above.

In one illustrative example, the treatment plan could be received from a health insurer. Different health insurers have developed over many years different treatment plans with which they want their insured members to comply. In some instances, the insurer will only pay for medication and other treatments specified in the treatment plan for a particular chronic disease. Thus a member insured by the relevant insurer will need to comply with the treatment plan in order to have their medication and other treatments paid for by the insurer. It is obviously very important for healthcare providers to know what treatment plans apply but in practice this has proved impossible due to the large number of different insurers resulting in a large number of different treatment plans.

The healthcare provider data includes information relating to the various healthcare providers that are currently providing various health-related facilities and/or services or have in the past provided health-related facilities and/or services to the patient.

All of the above data is stored in the database 20 and continually updated as required.

A treatment module 22 accesses the data stored in the database 20 and uses the data to determine a plurality of treatment activities required to implement a treatment plan thereby to treat the patient.

For example, using the treatment of a diabetic type 2 patient:
1. The treatment plan manager would define the steps required over a calendar year in order to treat the patient. As an example, the steps over a 12 month period could be:
   a. Two general practitioner visits
   b. Two pathology tests to check the glucose level
   c. One pathology test to check cholesterol levels
   d. One podiatry visit
   e. One ophthalmology visit
   f. One dietician visit
2. The system would then plan the order of these steps, spaced out over a twelve month period, so as to ensure the best sequence of steps for effective treatment and so as to balance the load of patient visits to the healthcare providers concerned. As an example the system could plan the following:
   a. Step 1: The first glucose level and the cholesterol test
   b. Step 2: The first general practitioner visit once the glucose and cholesterol test results are available
   c. Step 3: The dietician visit a month later to assist with a healthy eating plan
   d. Step 4: A routine podiatry visit in month four
   e. Step 5: The second glucose test in month six
   f. Step 6: The second general practitioner visit once the second glucose test result is available
   g. Step 7: A routine podiatry visit in month eight
   h. Step 8: A routine ophthalmology visit in month eight
3. Once the sequencing and timing of the steps are defined the activities within each step are set up by the system. As an example for Step 2 in the example above, the general practitioner visit, the following activities would be set up:
   a. The patient is notified of the upcoming general practitioner visit via a communication channel
   b. The agent of the healthcare provider is prompted to contact the patient in order to set up the appointment
   c. Once the appointment is scheduled the patient receives confirmation of the appointment via a communication channel
   d. The patient receives a reminder 48 hours before the appointment via a communication channel
   e. On the day of the appointment the agent of the healthcare provider is prompted to prepare the patient file by printing the consent, clinical assessment and patient dashboard forms
   f. The healthcare provider treats the patient in accordance with the assessment form, using the clinical data from the patient dashboard
   g. The agent of the healthcare provider is prompted to capture the clinical data measured during the visit into the system for record keeping
   h. The clinical data is then be sent to the treatment plan manager for analysis and record keeping
   i. Finally, the healthcare provider receives reporting from the rewards module to track performance in accordance with the pay for performance contract

This is accomplished by the treatment module 22 checking the relevant treatment plans for the patient and their condition to determine what treatment steps are required to comply with the treatment plan.

The treatment module 22 then accesses the patient medical data to ascertain what medication the patient has taken in the past or is currently taking and any other treatments that the patient has historically had or is currently undergoing.

The treatment module 22 then compares this with the determined treatment steps based on the treatment plan and determines the next step in the treatment of the patient and also determines a date by when this treatment must occur.

Finally, the treatment module 22 determines one or more treatment activities required to implement the next treatment step and the timing by when these activities must be performed.

The healthcare provider data is next accessed and the relevant healthcare provider to provide the next treatment activity is identified.

A communications module 24 communicates with a system of the identified healthcare provider to instruct the healthcare provider to perform the next activity in the treatment of the patient.

Where this is the first communication regarding a particular patient treatment or if the patient's treatment plan has changed, a full treatment plan is communicated to the system so that the healthcare provider has an overview of the full treatment plan at the beginning of the treatment.

The communications module 24 is also able to communicate with a system of the relevant treatment plan manager to receive the necessary treatment plans and to store these in the database as has been described above. Any changes to the treatment plans are received via the communications module 24 and stored in the database.

In addition, the communications module 24 also transmits any relevant data received from a healthcare provider back to the relevant treatment plan manager and may in some cases suggest changes in treatment plan to the insurer system. This will be described in more detail below.

In one example embodiment the system 10 periodically checks with the treatment plan manager system for treatment plan changes.

This could be accomplished in numerous ways. In one example embodiment the communications module 24 could communicate with an intermediate user of the system and provide them either via a digital display or a printout, for example, with information detailing the healthcare provider and the next steps to be taken in the treatment of the patient. The intermediate user will then contact the healthcare provider or an agent in the form of an assistant of the health care provider and instruct them of the necessary next steps to be taken to provide the determined next treatment to the patient.

In certain embodiments, the communications module 24 is connected via a communications network to a practice system (not shown) of the healthcare provider. The system may be a practice management system but may be integrated into another system of the healthcare provider or may be a stand alone system.

It will be appreciated that the communication can be achieved in any one of a number of ways including sending a data communication such as an e-mail, fax or text message. Alternatively or in addition, data could be transmitted to the practice's system which causes the practice's system to issue a reminder to a healthcare provider and/or their agent to perform an activity.

In this case, data is transmitted to the practice's system with information regarding the identity of the patient and information of the next treatment activity to be performed by the healthcare provider and/or their agent, and may be transmitted with a deadline by when the treatment activity should be conducted.

In addition, the data may include a reward for the healthcare provider and/or their agent if the treatment activity is performed by the deadline. The rewards aspect of the system will be described in more detail below.

If the healthcare provider and/or their agent do not have medical history information about the patient then medical history data is transmitted to the practice's system so that the healthcare provider has all of the necessary information at their fingertips at the time when they see the patient. This will obviously always occur if the healthcare provider has not previously seen the patient.

The information received by the system of the healthcare provider is used by the healthcare provider or an agent of the healthcare provider to contact the patient to book an appointment for the next treatment. A patient receiving a telephone call from their healthcare provider or their assistant to set up an appointment is far more likely to set up the appointment.

In order to motivate the healthcare provider to make the appointment within the required time, the system includes an awards module 26 and this will be described in more detail below.

Alternatively, an application is loaded onto the existing practice's system specifically to interface with the system 10 described above.

The application provides a graphical user interface whereby an assistant such as a secretary or receptionist at the healthcare practice is provided with a list of patients to be contacted, their contact information and the treatment that is required to be provided to them or if they are to simply come in for a checkup.

The application runs in a task-based environment so that when the patient is contacted and an appointment is set up their names are removed from the list of names of patients to be contacted.

The application also allows downloading of any information that the healthcare provider is missing regarding the patient and treatment plan to be implemented.

Embodiments of the system 10 also include a monitoring module 32.

In one example embodiment, the monitoring module 32 may be included in the application which includes a template for easy capture of any updated treatment, medical information, test results or any other relevant information to be transmitted back to the healthcare system 10. The healthcare provider or their agent is prompted by the application to update the template and capture the information.

Thus, once the healthcare provider or their agent has performed the next treatment activity they transmit all information regarding the treatment carried out together with any other relevant information regarding the patient's current medical condition back to the communications module 24 and all of this information is then stored in the database 20 so that at any given time full patient information is on record.

It will be appreciated that information such as any procedures carried out on the patient, any test results such as blood test results to name but one example and any medication changes are transmitted back to the communications module 24 and stored in the database 20.

It will be appreciated that sometimes the information transmitted back will require an automatic change of the treatment plan applied e.g. worsening of the condition that requires upgrading the patient to a different treatment plan. This would then mean that the system 10 will re-determine the activities required to implement the treatment plan and store the new activities in the database 20.

The monitoring module 32 may further escalate the instruction to the healthcare provider or their agent if the activity is not carried out. The escalation will typically take the form of a further communication regarding the outstanding activity and the further communication will be issued if the monitoring module 32 determines that the activity is not performed within a predetermined time frame.

The escalation may take various forms, for example, if the original communication was to the agent of the healthcare provider the escalation communication may be to the agent and the healthcare provider. In addition, other relevant stakeholders could be communicated with in the escalation communication.

In one example embodiment the treatment module 22 assesses the information returned to check if any treatment plan changes are required. If a treatment plan change is required a message is transmitted via the communications module 24 to the treatment plan manager, in this case being the insurer.

In another example embodiment, any treatment plan changes could be advised by a dedicated clinical decision support system. In this embodiment, the communications module 24 transmits all relevant data to the clinical decision support system and receives back any recommended treatment plan changes.

Alternatively, the insurer, on receipt of any updated information can instruct the system 10 to implement a treatment plan change.

In one example embodiment, upon receipt of the relevant information a message is transmitted to the insurer with the details of the treatment carried out and requesting a payment to the healthcare provider.

The insurer may request further treatment, information or tests, for example, by transmitting a message back to the system 10 and the system then schedules the relevant treatment or test with the selected healthcare provider as has been described above.

For example the insurer may decide that they need:
patient weight
patient height
BMI
an additional test to be done
blood pressure
x-rays to be done
a copy of the doctors notes

The awards module 26 keeps track of the number of patients seen by the healthcare provider within the required time frame and determines a suitable reward for the healthcare provider in order to motivate the healthcare provider to work through the list of patients supplied to them.

In one example embodiment, the awards system is implemented by the insurer paying a premium to the healthcare provider for the treatment compared to the amount they would normally pay for such a treatment. Thus, a healthcare provider may earn 10% more, for example, for each of the patients that are referred to them by the healthcare system 10.

In order to further motivate the healthcare provider, they are provided with information periodically, such as at the end of each month, reporting on the number of patients referred to them from the healthcare system that they actually saw. The information may include the amount of fees that the healthcare provider missed out on by not seeing some of those patients referred to them. This of course will assist in pressurising the healthcare provider to see all of the patients.

Where the agent of the healthcare provider is performing the activities it will be appreciated that the healthcare provider is informed of the agent's performance periodically, such as at the end of every month.

In one example embodiment, this reporting functionality is built into the application that is transmitted to the healthcare provider's practice management system.

The system may also include a data module 30 to determine what data is required by the healthcare system and to request the data from one or more of the patient, the insurer, a healthcare provider or a third party.

It will be appreciated that the above system tackles some of the issues required to make patients treatment plan compliant. Some of these issues are as follows.

It has been found by the applicant that healthcare provider driven care management has fundamentally a different level of adherence when compared to other methods of driving care management.

The treatment plan manager is able to communicate their treatment plan to all of the healthcare providers that may encounter its members.

The healthcare provider is instructed and motivated to action the relevant treatment plan by the system.

The healthcare provider has all the relevant information at their disposal about the patient and the relevant treatment plan, including clinical history, adherence to medication etc.

This will enable the healthcare provider to make the right diagnosis and treatment decisions such as referrals and medication.

Finally, the healthcare provider is motivated to engage the patient and is therefore able to influence the patient to take the appropriate treatment actions (take medication, book an appointment in 3 months, etc) and is hopefully able to influence the patient to make the appropriate lifestyle changes (diet, obesity, exercise, stress, etc).

Thus, a method and system is provided to enable healthcare providers to treat patients suffering with chronic conditions in accordance with treatment plans set and updated by the insurers/managed care organizations where a healthcare provider has contracted with an insurer/managed care organization on a pay for performance basis.

Embodiments of the method and system, in accordance with the treatment plans and contract, notifies the provider and patient of patient encounters that are due, presents the latest patient health information available to the provider in preparation of the encounter, requests new patient information collected from the healthcare provider during the encounter and provides the healthcare provider with reporting and tracking on how the pay for performance contract is delivered to.

The system described above effectively orchestrates the required interactions between healthcare providers, patients and insurers to effectively implement managed care, and provides a mechanism to reimburse providers to the extent that they comply with the treatment plan.

1. A healthcare system for managing the treatment of a patient by a healthcare provider, the system comprising:
a database having stored thereon a group of data comprising patient information data, patient medical data, treatment plan data and healthcare provider data;
a treatment module to access the database and to generate a first report comprising a plurality of patient treatment activities that are required to implement a treatment plan to thereby treat the patient, wherein the first report is based on at least some of the data from the group of data;
a communications module to transmit an instruction to perform at least one activity of the plurality of patient treatment activities to a healthcare provider system, and further, to receive a second report from the healthcare provider system, wherein the second report identifies at least one activity of the plurality of patient treatment activities performed by the healthcare provider; and
a monitoring module to identify an unperformed activity of the plurality of patient treatment activities that has not been performed by the healthcare provider.

2. A system according to claim 1, further comprising an awards module to determine an award for the healthcare provider or their agent if the healthcare provider or their agent performs an activity of the plurality of patient treatment activities.

3. A system according to claim 1, further comprising a data module to identify data required by the healthcare system, and wherein the communications module transmits a request for the data to the patient, an insurer system, or the healthcare provider system.

4. A system according to claim 1, wherein the communications module receives the treatment plan data from a treatment plan manager system.

5. A system according to claim 4, wherein the treatment plan manager system comprises at least one of an insurer system, the healthcare provider system, or a managed-care provider system.

6. A system according to claim 1, wherein patient information data comprises at least one of a name of the patient, a gender of the patient, an age of the patient, or an identification number of the patient.

7. A system according to claim 1, wherein patient medical data comprises at least one of a medical history of the patient, an allergy of the patient, a medication of the patient, or a treatment of the patient.

8. A system according to claim 1, wherein the plurality of patient treatment activities comprises at least one of a test to be performed on the patient or a consultation between the patient and the healthcare provider.

9. A method for managing the treatment of a patient by a healthcare provider, the method comprising:
accessing a group of data comprising patient information data, patient medical data, treatment plan data and healthcare provider data;
generating a first report comprising a plurality of patient treatment activities required to implement a treatment plan thereby to treat the patient, wherein the first report is based on at least some of the data from the group of data;
transmitting an instruction to perform at least one activity of the plurality of patient treatment activities to a healthcare provider system;
receiving a second report from the healthcare provider system, wherein the second report identifies at least one activity of the plurality of patient treatment activities performed by the healthcare provider;
identifying an unperformed activity of the plurality of patient treatment activities that has not been performed by the healthcare provider; and
transmitting an instruction to perform the unperformed activity to the healthcare provider system.

10. A method according to claim 9, further comprising determining an award for the healthcare provider or their agent if the healthcare provider or their agent performs an activity of the plurality of patient treatment activities.

11. A method according to claim 10, further comprising transmitting information relating to the award to the healthcare provider system.

12. A method according to claim 9, further comprising receiving the treatment plan data from at least one of an insurer system, the healthcare provider system, or a managed-care provider system.

13. A method according to claim 9, further comprising transmitting a request for data to the healthcare provider system.

14. A method according to claim 9, further comprising transmitting a requested date by which the unperformed activity should be performed to the healthcare provider system.

15. A method according to claim 14, further comprising transmitting an instruction to the healthcare provider system if the healthcare provider does not perform the unperformed activity by the requested date.

16. A method according to claim 9, further comprising generating a third report comprising at least one patient treatment activity, wherein the at least one patient treatment activity of the third report is different than the plurality of patient treatment activities of the first report.

17. A method for managing the treatment of a patient by a healthcare provider, the method comprising:
receiving a treatment plan from an insurer system;
accessing a group of data comprising a name of the patient, a gender of the patient, an age of the patient, and a medical history of the patient;
generating a first report comprising a plurality of patient treatment activities, wherein the first report is based on the treatment plan and the group of data;
transmitting an instruction to perform at least one activity of the plurality of patient treatment activities to a healthcare provider system;
receiving a second report from the healthcare provider system, wherein the second report identifies a performed activity of the plurality of patient treatment activities that has been performed;
identifying an unperformed activity of the plurality of patient treatment activities that has not been performed; and
transmitting a requested date by which the unperformed activity should be performed to the healthcare provider system.

18. A method according to claim 17, further comprising transmitting information relating to an award if the unperformed activity is performed by the requested date.

19. A method according to claim 17, further comprising receiving a test result from the healthcare provider system.

20. A method according to claim 19, further comprising generating a third report comprising at least one patient treatment activity, wherein the third report is based on the test result, and wherein the at least one patient treatment activity of the third report is different than the plurality of patient treatment activities of the first report.
